(19) United States
(12) Patent Application Publication
(10) Pub. No.: US 2025/0097315 A1
(43) Pub. Date: Mar. 20, 2025

(54) INFORMATION PRESENTATION METHOD AND DEVICE, EQUIPMENT AND STORAGE MEDIUM

(71) Applicant: Beijing Zitiao Network Technology Co., Ltd., Beijing (CN)

(72) Inventor: Xiaochuang LU, Beijing (CN)

(21) Appl. No.: 18/806,302

(22) Filed: Aug. 15, 2024

(30) Foreign Application Priority Data
Sep. 14, 2023 (CN) 202311190563.7

(51) Int. Cl. H04L 67/568; G06F 3/04815; H04L 67/06

(52) U.S. Cl. CPC H04L 67/568; G06F 3/04815; H04L 67/06

(57) ABSTRACT

Embodiments of the disclosure provides a method, apparatus, device, and a storage medium for information presentation. The method includes: presenting a three-dimensional computer-generated environment through a display, and displaying a first application interface and a second application interface on the three-dimensional computer-generated environment, where the first application and the second application are of different types of operating system applications; in response to a first operation for the first application interface, uploading the target information obtained by the first operation to a bound cloud sharing space; and in response to a second operation for the second application interface, transferring the target information to the second application interface for presentation through the cloud sharing space.

### CROSS-REFERENCES

The present application claims priority to Chinese Patent Application No. 202311190563.7, filed on Sep. 14, 2023, and entitled “METHOD, APPARATUS, DEVICE AND STORAGE MEDIUM FOR PRESENTING INFORMATION”, the entirety of which is cooperated therein by reference.

### FIELD

Embodiments of the present disclosure relate to the technical field of data processing, in particular to a method, apparatus, device and storage medium for presenting information.

### BACKGROUND

Nowadays, an application scenario of an extended reality (XR) technology is more and more widely used, and specifically includes Virtual Reality (VR), Augmented Reality (AR), Mixed Reality (MR), and the like. In order to realize diversified interactions in the virtual scene, the XR device can be connected with other devices under different operating systems, and the device interfaces under different operating systems are presented in the virtual reality environment provided by the XR device, so that application interfaces under multiple operating systems exists in the virtual reality environment, so that the user performs corresponding information interaction in the application interface of each operating system of the virtual reality environment.

However, due to the problem of information islanding between different operating systems, information transfer cannot be performed between application interfaces of different operating systems in the virtual reality environment, resulting in some limitations of information transfer in the virtual reality environment, which greatly reduces convenient interaction of the user in the virtual reality environment.

### SUMMARY

Embodiments of the present disclosure provide a method, apparatus, device, and storage medium for presenting information, which implements seamless transferring of information between application interfaces under different types of operating systems in a three-dimensional computer-generated environment, ensures comprehensive applicability of information transmission in a three-dimensional computer-generated environment, and improves convenience and reliability of information transmission in a three-dimensional computer-generated environment.

According to a first aspect, embodiments of the present disclosure provide a method for presenting information, and the method includes:
at an electronic device in communication with a display and one or more input devices:
presenting a three-dimensional computer-generated environment via the display, and displaying a first application interface and a second application interface on the three-dimensional computer-generated environment, the first application and the second application being of different types of operating system applications;
in response to a first operation for the first application interface, uploading target information obtained by the first operation to a bound cloud sharing space;
in response to a second operation for the second application interface, transferring the target information to the second application interface for presentation through the cloud sharing space.

According to a second aspect, embodiments of the present disclosure provide an apparatus for information presentation, and the apparatus includes:
an electronic device in communication with a display and one or more input devices configured with,
an environment presentation module configured to present a three-dimensional computer-generated environment via the display, and display a first application interface and a second application interface on the three-dimensional computer-generated environment, the first application and the second application being of different types of operating system applications;
an information uploading module configured to upload target information obtained by a first operation to a bound cloud sharing space in response to the first operation for the first application interface;
an information transferring module configured to transfer the target information to the second application interface for presentation through the cloud sharing space in response to a second operation for the second application interface.

According to a third aspect, embodiments of the present disclosure provide an electronic device, including:
a processor and a memory, where the memory is configured to store a computer program, and the processor is configured to invoke and run the computer program stored in the memory to perform the information presentation method provided in the first aspect of the present disclosure.

According to a fourth aspect, embodiments of the present disclosure provide a computer-readable storage medium, configured to store a computer program, where the computer program causes a computer to perform the information presentation method provided in the first aspect of the present disclosure.

According to a fifth aspect, embodiments of the present disclosure provides a computer program product, including a computer program/instruction, where the computer program/instruction causes a computer to perform the information presentation method according to the first aspect of the present disclosure.

According to the technical solutions of the present disclosure, the three-dimensional computer-generated environment is presented via the display of the electronic device, the first application interface and the second application interface are displayed on the three-dimensional computer-generated environment, and the first application and the second application are of different types of operating system applications. Then, for the first application interface and the second application interface in different types of operating systems in the three-dimensional computer-generated environment, if the first operation for the first application interface is detected, the target information obtained by the first operation may be uploaded to the bound cloud sharing space. Then, if the second operation for the second application interface is detected, the target information may be transferred to the second application interface for presentation through the cloud sharing space, thereby realizing seamless transferring of information between application interfaces under different types of operating systems in the three-dimensional computer-generated environment, eliminating the problem of information islanding existing between application interfaces under different types of operating systems, ensuring comprehensive applicability of information transmission in the three-dimensional computer-generated environment, and improving convenience and reliability of information transmission in the three-dimensional computer-generated environment.

### BRIEF DESCRIPTION OF DRAWINGS

In order to more clearly illustrate the technical solutions in embodiments of the present disclosure, the accompanying drawings that need to be used in the description of embodiments are briefly described below, and obviously, the drawings in the following description are merely some embodiments of the present disclosure, and for those of ordinary skill in the art, other drawings may be obtained based on these drawings without creative work.

FIG. 1 is a flowchart of an information presentation method according to an embodiment of the present disclosure;

FIG. 2 is a flowchart of another information presentation method according to an embodiment of the present disclosure;

FIG. 3 is a schematic principle diagram of an information transferring process between application interfaces under different types of operating systems in a three-dimensional computer-generated environment according to an embodiment of the present disclosure;

FIG. 4 is a flowchart of another information presentation method according to an embodiment of the present disclosure;

FIG. 5 is a schematic diagram of an information presentation apparatus according to an embodiment of the present disclosure; and

FIG. 6 is a schematic block diagram of an electronic device according to an embodiment of the present disclosure.

### DETAILED DESCRIPTION

The technical solutions in embodiments of the present disclosure are clearly and completely described below with reference to the accompanying drawings in the embodiments of the present disclosure. All other embodiments obtained by those skilled in the art without creative efforts shall fall within the scope of the present application.

It should be noted that the terms “first”, “second”, and the like in the specification and claims of the present disclosure and the foregoing drawings are used to distinguish similar objects, and are not necessarily used to describe a specific order or sequence. It should be understood that such used data may be interchanged where appropriate so that embodiments of the present application described herein can be implemented in an order other than those illustrated or described herein. Moreover, the terms “comprising” and “having” and any deformation thereof are intended to cover a non-exclusive inclusion, e.g., a process, method, system, product, or server containing a series of steps or units not necessarily limited to those steps or units expressly listed, but may include other steps or units not expressly listed or inherent to such processes, methods, products, or devices.

In the embodiments of the present disclosure, words such as “exemplary” or “for example” are used to indicate examples, illustrations, or descriptions, and any embodiment or solution described as “example” or “for example” in the embodiments of the present disclosure should not be construed as being more preferred or advantageous than other embodiments or solutions. Rather, words such as “example” or “for example” are intended to present related concept in a specific manner.

Before describing a specific technical solution of the present disclosure, the application scenario of the present disclosure is correspondingly described.

In order to realize information exchange in the virtual reality environment, the present disclosure may pre-construct a virtual reality environment through a computer as the three-dimensional computer-generated environment in the present disclosure. Then, at any electronic device in communication with the display and the one or more input devices, a corresponding three-dimensional computer-generated environment may be displayed through a display of the electronic device, so that the user enters into the three-dimensional computer-generated environment to perform corresponding information exchange on each virtual object in the three-dimensional computer-generated environment.

The electronic device may be any XR device, and may specifically include a VR device, an AR device, and an MR device, which is not limited in the present disclosure.

The display may be any display screen or the like that is in communication connection with the electronic device. For example, the display may be a display screen configured on the VR device, the AR device, or the MR device, which is not limited in the present disclosure.

Moreover, in order to achieve the normal interaction of the user in the three-dimensional computer-generated environment, the present application may initiate a corresponding interaction operation on various types of information in the three-dimensional computer-generated environment displayed by the display through one or more input devices in communication with the electronic device. thereby enabling the user to perform various information interactions in the three-dimensional computer-generated environment.

The one or more input devices may be any control devices and information collection devices that establish a communication connection with the electronic device. For example, the one or more input devices may be a VR device, an AR device, or a handle configured on the MR device, or a collection module configured to detect hand operations, eye movement information, or a voice collector configured to collect user voice information, which is not limited in the present disclosure.

At present, in order to solve the problem that information transfer cannot be transferred between application interfaces of different types of operating systems in a virtual reality environment due to the presence of information islands between different operating systems, the inventive concept of the present disclosure is to: pre-bind a cloud sharing space of a cross-operating system for a three-dimensional computer-generated environment, and use the cloud sharing space as an information transfer medium transfer station between application interfaces of any two different types of operating systems in the three-dimensional computer-generated environment to realize seamless transferring of information between application interfaces of different types of operating systems in the three-dimensional computer-generated environment, to ensure comprehensive applicability of information transfer in the three-dimensional computer-generated environment across the cross-operating system.

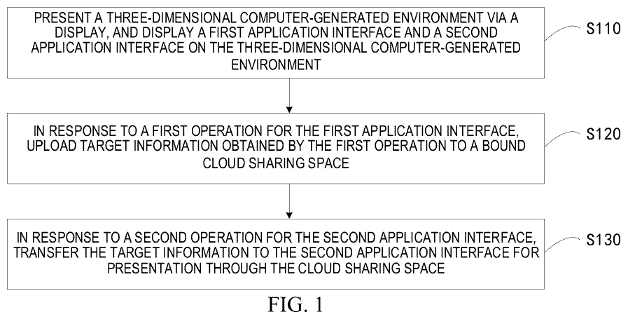

FIG. 1 is a flowchart of a method for presenting information according to an embodiment of the present disclosure. The method may be performed, but not limited to, by the apparatus for presenting information provided in the present disclosure. The apparatus for presenting information may be implemented in any software and/or hardware manner. For example, the apparatus for information presentation may be configured in an electronic device capable of simulating a virtual scene, such as an AR/VR/MR, which is not limited in the present disclosure.

Specifically, as shown in FIG. 1, the method may include the following steps:
S110, presenting a three-dimensional computer-generated environment via the display, and displaying a first application interface and a second application interface on the three-dimensional computer-generated environment.

The three-dimensional computer-generated environment may be a corresponding virtual environment simulated by the electronic device for a certain interactive scene selected by any user, or the electronic device may display a corresponding type of interactive information in the three-dimensional computer-generated environment by enabling a corresponding real environment captured by a Video See-Through (VST) function.

In the present disclosure, the three-dimensional computer-generated environment may include, but is not limited to, the following three types:

### 1) Pure Imaginary Virtual Scene

The computer can pre-construct pure virtual spaces under various types, and the pure virtual spaces includes various pure imaginary virtual objects to form a pure virtual scene.

For example, a pure imaginary performance space of a bar may be established, and the whole pure imaginary performance space may include a virtual person representing a performer, or may include a virtual person representing a viewer, and may further include virtual objects representing various objects in the bar.

### 2) The Captured Real Environment

By enabling the VST function configured by the electronic device, the real environment in which the user is currently located can be captured in real time, so that the real environment picture where the user is located is continuously collected and presented via the display.

### 3) Semi-Virtual Semi-Simulation Scene Fused by Virtual Environment and Real Environment

By enabling the VST function configured by the electronic device, the real environment in which the user is currently located can be captured in real time, so that the real environment picture where the user is located is continuously collected and presented via the display. Moreover, the corresponding virtual object may be pre-constructed by the computer, and the virtual object may be displayed via the display while the real environment image may further be displayed via the display, so as to realize the fusion of the virtual object and the real environment. Then, the semi-virtual semi-simulation scene fused by the virtual environment and the reality environment can be presented via the display.

For example, the semi-virtual semi-simulation scenario in the present disclosure may be an MR space generated by using mixed reality (MR) technology.

### 4) Live Broadcast Interaction Scene Composed of Video Playing Field and Unity Interaction Field

In order to ensure that a user experiences a space feeling and a three-dimensional feeling of three-dimensional live streaming interaction in an immersive experience in a virtual reality environment. a live streaming interactive scene composed of a video playing field and a Unity interactive field of 3D may be specially constructed as the virtual reality environment in the present disclosure.

The Unity interaction field may be used to present various virtual objects constructed by the user for the corresponding live broadcast scene by using the Unity engine, so as to support the user to control the virtual controller to generate a corresponding interactive operation with each virtual object.

The video playing field may be used to present a live video stream of any live broadcast room that the user wants to watch, and an interaction special effect generated after the user performs various interactive operations on each virtual object.

It can be learned from the foregoing content that, after the three-dimensional computer-generated environment is determined, the three-dimensional computer-generated environment may be presented through a display communicatively connected to the electronic device, so that the user enters the three-dimensional computer-generated environment. The display may be any display screen, for example, a VR device, an AR device, or a display screen configured on the MR device.

Moreover, in order to realize diversified information interaction in the three-dimensional computer-generated environment, the electronic device may usually be connected to other devices under different operating systems, and the application interfaces displayed by devices in different operating system are presented in the three-dimensional computer generated environment provided by the electronic device.

Then, when the three-dimensional computer-generated environment is presented via the display, the present disclosure further displays the first application interface and the second application interface on the three-dimensional computer-generated environment.

The first application may be any type of operating system application that supports display for the three-dimensional computer-generated environment, and the second application may be another type of operating system application that supports display for the three-dimensional computer-generated environment, so that the first application and the second application are of different types of operating system applications. In this case, there may be a plurality of application interfaces under a plurality of operating systems within the three-dimensional computer-generated environment, which facilitates the user to perform corresponding information interaction in the application interface of each operating system of the three-dimensional computer-generated environment.
S120, in response to a first operation for the first application interface, uploading target information obtained by the first operation to the bound cloud sharing space.

It can be understood that, in order to ensure that the user can successfully perform various interaction operations in the three-dimensional computer-generated environment, the user usually needs to register a user account in the three-dimensional computer-generated environment, and successfully log in to the three-dimensional computer-generated environment by using the user account, so that the user can have a specific identifier in the three-dimensional computer-generated environment to support the user in performing various interaction operations in the three-dimensional computer-generated environment.

In order to ensure comprehensive interactions of a user in a three-dimensional computer-generated environment, it is necessary to support a user to perform various interactive operations in the plurality of application interfaces under different types of operating systems in the three-dimensional computer-generated environment. Due to the problem of information islanding between different operating systems, information transferring cannot be realized between application interfaces of different types of operating systems in the three-dimensional computer-generated environment, and comprehensive interactions of the user in the three-dimensional computer-generated environment cannot be ensured.

Therefore, after the user enters the three-dimensional computer generating environment, an independent temporary storage space may be specially constructed for the user in the cloud server as the bound cloud sharing space according to the present disclosure. The cloud sharing space and the application interface under each operating system in the three-dimensional computer generating environment may respectively establish corresponding communication connections to support information exchange of the cloud sharing space under the cross-operating system. In other words, a corresponding communication connection may be established between the cloud sharing space and the first application interface and the second application interface in the three-dimensional computer-generated environment, to support the cloud sharing space for information exchange between the first application interface and the second application interface.

Therefore, the cloud sharing space across the operating systems can be used as an information transferring replay station among the plurality of application interfaces of different types of operating systems in the three-dimensional computer-generated environment, so that information seamless transferring between the plurality of application interfaces of different types of operating systems is realized.

In the present disclosure, whether the user performs a corresponding first operation in the first application interface may be detected in real time within the three-dimensional computer-generated environment, where the first operation may be an initiation operation of information transferring, to determine whether the user currently needs to display some contents in the first application interface into a certain application interface under another type of operating system in the three-dimensional computer-generated environment. The first operation may include, but is not limited to, various information transferring operations that the user is accustomed to using information interaction between different application interfaces by a user, such as a copy operation, a drag operation, and a forwarding operation performed by a certain part of content in the first application interface, without requiring the user to change the information transferring operation habit of the user for different application interfaces, and ensuring the operation convenience of the user during information transfer between the plurality application interfaces of different types of operating systems.

Then, when the first operation on the first application interface is detected, it is indicated that the user currently wants to display some contents in the first application interface into the application interface of the other operating system. Therefore, by parsing the first operation, a part of contents that the user selects to participate in this information transferring in the first application interface may be obtained as the target information in the present disclosure.

The target information in the present disclosure may include, but is not limited to, text information, pictures, audio, and video in the first application interface.

Then, the target information obtained by the first operation is directly uploaded to the bound cloud sharing space, so that the cloud sharing space acts as information transferring replay station among the plurality of application interfaces of different types of operating systems and may transmit the target information to the application interface of the other operating system in the three-dimensional computer-generated environment to display, so as to realize seamless transferring of information among application interfaces of different types of operating systems in the three-dimensional computer-generated environment.
S130, in response to a second operation for the second application interface, transferring the target information to a second application interface for presentation through the cloud sharing space.

It can be learned from the foregoing contents that the second application interface may be any other application interface in the three-dimensional computer-generated environment that belongs to different types of operating systems from the first application interface.

When the second operation performed by the user on the second application interface is detected. the second operation may be that the user performs a corresponding information transferring confirmation operation in the second application interface, to indicate that the target information in the first application interface needs to be transferred to the second application interface for display. Therefore, in response to the second operation for the second application interface, the present disclosure may download the target information stored into the second application interface through the cloud sharing space, and successfully present the target information in the second application interface, thereby implementing seamless transferring of information from the first application interface to the second application interface under different types of operating systems.

Therefore, for the application interfaces under any two different types of operating systems in the three-dimensional computer-generated environment, the target information in the application interface under one operating system can be forwarded to the application interface under the other operating system for presentation through the cloud sharing space as the replay station in the information transfer, so that the problem of information islanding existing between multiple application interfaces under different types of operating systems is eliminated, and the comprehensive applicability of information transfer in the three-dimensional computer-generated environment is ensured.

According to technical solutions provided by embodiments of the present disclosure, the three-dimensional computer-generated environment is presented via the display of the electronic device, the first application interface and the second application interface are displayed on the three-dimensional computer-generated environment, and the first application and the second application are of different types of operating system applications. Then, for the first application interface and the second application interface under different types of operating systems in the three-dimensional computer-generated environment, when the first operation for the first application interface is detected, the target information obtained by the first operation may be uploaded to the bound cloud sharing space. Then, when the second operation for the second application interface is detected, the target information can be transferred to the second application interface for presentation through the cloud sharing space, thereby realizing seamless transmission of information between application interfaces under different types of operating systems in the three-dimensional computer-generated environment, eliminating the problem of information islanding existing between application interfaces under different types of operating systems, ensuring comprehensive applicability of information transferring in the three-dimensional computer-generated environment, and improving convenience and reliability of information transferring in the three-dimensional computer-generated environment.

As an optional implementation solution of the present disclosure, in order to ensure accuracy of information transferring between a plurality of application interfaces under different types of operating systems in the three-dimensional computer-generated environment, the present disclosure may describe, in detail, an information transferring process between the plurality of application interfaces under different types of operating systems through a cloud sharing space.

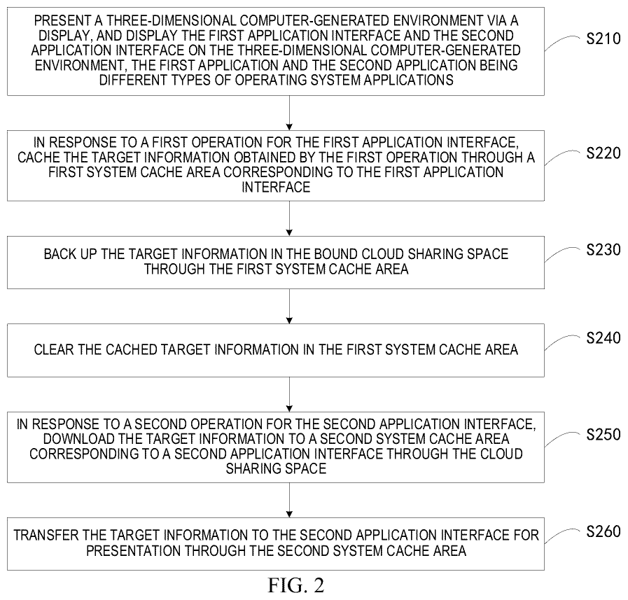

FIG. 2 is a flowchart of another information presentation method according to an embodiment of the present disclosure.
S210, presenting a three-dimensional computer-generated environment via a display, and displaying the first application interface and the second application interface on the three-dimensional computer-generated environment, the first application and the second application being of different types of operating system applications.
S220, in response to the first operation for the first application interface, caching the target information obtained by the first operation through a first system cache area corresponding to the first application interface.

In order to optimize information transferring performance among the plurality of application interfaces under each operating system, the present disclosure may respectively set a system cache area for the application interface under each operating system which is configured to temporarily store related target information in an application interface under a corresponding operating system, so that information transferring and sharing between application interfaces under different types of operating systems are possible.

It may be understood that the memory space of the system cache area corresponding to the application interface under different types of operating systems may change with the size of the cached target information, and the memory space thereof is not fixed.

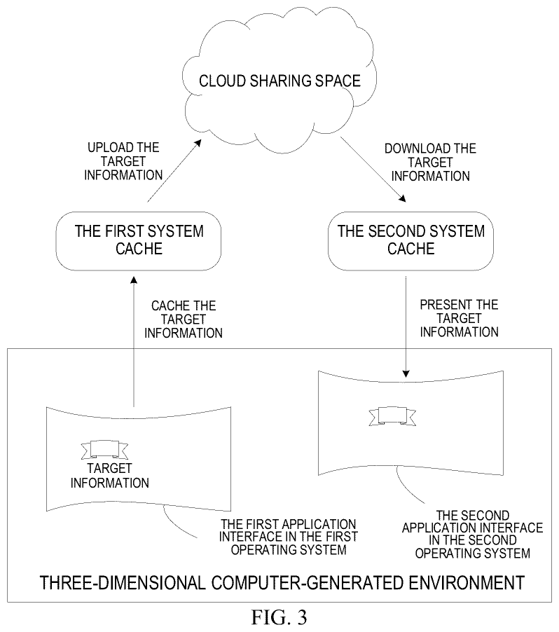

In the present disclosure, when the first operation on the first application interface is detected, as shown in FIG. 3, the first system cache area set for the first application interface and the target information obtained by the user through the first operation may be first determined. Then, the target information is temporarily cached in the first system cache area corresponding to the first application interface, so that the target information is subsequently uploaded to the cloud sharing space through the first system cache area, so that the restriction relationship formed between the first application interface and the cloud sharing space due to direct interaction is released, so that the first application interface does not need to pay attention to whether the target information has been successfully uploaded to the cloud sharing space, which can support quick response to other user operations in the first application interface, and improve the operation performance in the application interface under each operating system.
S230, backing up the target information in the bound cloud sharing space through the first system cache area.

After the target information in the first application interface is cached to the first system cache area corresponding to the first application interface, through the established communication connection between the first system cache area and the bound cloud sharing space, as shown in FIG. 3, the cached target information may be sent to the cloud sharing space by using the first system cache area, so that the target information is backed up in the cloud sharing space, so that the target information is subsequently forwarded to the application interface (that is, the second application interface in the present disclosure) under another operating system in the three-dimensional computer-generated environment, to implement information circulation between different operating system interfaces in the virtual space.
S240, clearing the cached target information in the first system cache area.

After the backup of the target information in the cloud sharing space is completed through the first system cache area, in order to ensure the accuracy of the next information transferring in the first application interface, the present disclosure may also clear the currently cached target information in the first system cache area in time, so that when the next information transferring is performed in the first application interface, the next target information can be accurately cached, repeated transmission of adjacent target information is avoided, and information transferring accuracy between multiple application interfaces under different types of operating systems is ensured.
S250, in response to the second operation for the second application interface, downloading the target information to the second system cache area corresponding to the second application interface through the cloud sharing space.

In order to optimize the information transfer performance among the various operating systems, the second application interface in the present disclosure may be correspondingly provided with a second system cache area.

Then, when the second operation of the user for the second application interface is detected, it indicates that the target information in the first application interface needs to be transferred to the second application interface for display. Therefore, in response to the second operation for the second application interface, the present disclosure may first determine the second system cache area corresponding to the second application interface. Then, as shown in FIG. 3, through the cloud sharing space, the target information backed up therein may be downloaded into the second system cache area, so that the target information is subsequently transferred to the second application interface for presentation by the second system cache area.

It may be understood that, in order to ensure the accuracy of information transfer among the plurality of application interfaces under different types of operating systems, the second system cache area is prevented from presenting the previous cached target information in the second application interface, before the target information is downloaded into the second system cache area corresponding to the second application interface through the cloud sharing space, the cached content in the second system cache area may be cleared first, so that the second system cache area may remain in a cleared state before each information transferring, so as to accurately download the target information that needs to be transferred this time, and ensure the accuracy of information transferring among the plurality of application interfaces under different types of operating systems.
S260, transferring the target information to the second application interface for presentation through the second system cache area.

After the target information in the first application interface is downloaded in the second system cache area, the downloaded target information may be directly transferred to the second application interface for presentation through the second system cache area, thereby realizing seamless transferring of information from the first application interface to the second application interface under different types of operating systems.

Taking an example where the user copies a certain text content in the first application interface within the three dimensional computer-generated environment and past the certain text content to the second application interface, the copying operation in the first application interface may be the first operation, the pasting operation in the second application interface may be the second operation, and the text content selected by the user in the first application interface may be the target information.

Then, in response to the copying operation in the first application interface, the text content represented by the target information may be copied to the clipboard in the first operating system where the first application interface is located, and the clipboard under the first operating system may be the first system cache area corresponding to the first application interface. Then, the clipboard copied in the first operating system is uploaded to the cloud sharing space for backup.

Further, in response to the pasting operation of the second application interface, cached contents in the clipboard in the second operating system where the second application interface is located is cleared in advance, and the clipboard in the second operating system may be the second system cache area corresponding to the second application interface. Then, the text content backed up in the cloud sharing space (that is, the target information) is downloaded into the clipboard under the second operating system, and the target information is pasted into the second application interface by the clipboard under the second operating system for presentation, thereby realizing seamless information transferring from the first application interface to the second application interface.

According to technical solutions provided by embodiments of the present disclosure, the three-dimensional computer-generated environment is presented through the display of the electronic equipment, the first application interface and the second application interface are displayed on the three-dimensional computer-generated environment, and the first application and the second application are of different types of operating system applications. Then, for the first application interface and the second application interface under different types of operating systems in the three-dimensional computer-generated environment, when the first operation for the first application interface is detected, the target information obtained by the first operation may be uploaded to the bound cloud sharing space. Then, when the second operation for the second application interface is detected, the target information can be transferred to the second application interface for presentation through the cloud sharing space, thereby realizing seamless transmission of information between application interfaces under different types of operating systems in the three-dimensional computer-generated environment, eliminating the problem of information islanding existing between application interfaces under different types of operating systems, ensuring comprehensive applicability of information transmission in the three-dimensional computer-generated environment, and improving convenience and reliability of information transmission in the three-dimensional computer-generated environment.

According to one or more embodiments of the present disclosure, in order to ensure accuracy of information transferring between the plurality of application interfaces under different types of operating systems in the three-dimensional computer-generated environment, there is a corresponding requirement for a binding manner, a backup state, and whether information transferring currently supported in the cloud sharing space. Different states of the cloud sharing space in the information transferring process can be described in detail.

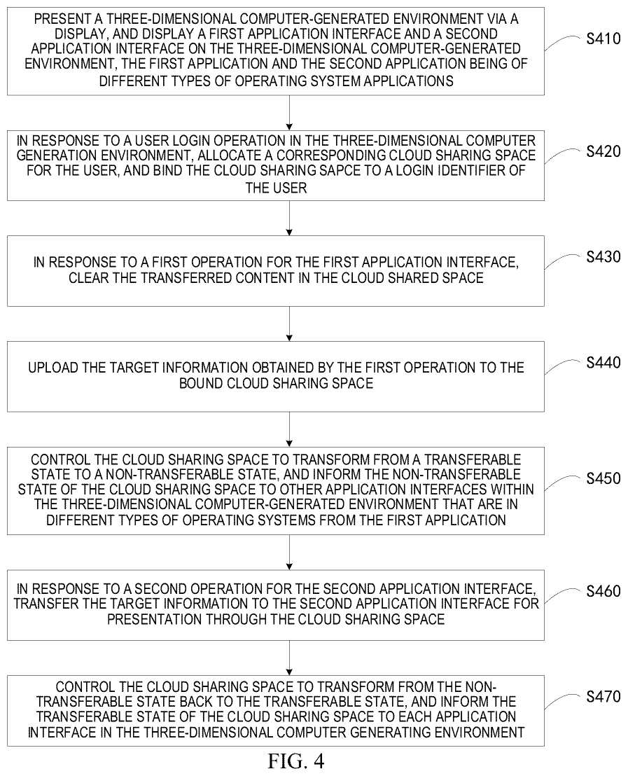

FIG. 4 is a flowchart of another information presentation method according to an embodiment of the present disclosure. The method includes the followings:
S410, presenting a three-dimensional computer-generated environment via a display, and displaying the first application interface and the second application interface on the three-dimensional computer-generated environment, the first application and the second application being of different types of operating system applications.
S420, in response to a user login operation in the three-dimensional computer-generated environment, allocating a corresponding cloud sharing space for the user, and binding the corresponding cloud sharing space to a login identifier of the user.

When a plurality of users enters the same three-dimensional computer-generated environment. each user may perform different interactive operations on an application interface under each operating system in the three-dimensional computer-generated environment. Therefore, in order to ensure the accuracy of information transferring between application interfaces under different types of operating systems in the three-dimensional computer-generated environment, the present disclosure may bind a cloud sharing space for each user.

Therefore, when the login operation of any user in the three-dimensional computer-generated environment is detected, a separate temporary storage space is first created/opened for the user in the cloud server as the cloud sharing space allocated to the user in the present disclosure. Moreover, the cloud sharing space allocated for each user is bound to the login identifier of the user, so that when each user performs an information transferring operation between application interfaces under different types of operating systems in the three-dimensional computer-generated environment, the cloud sharing space bound to the user can be accurately found through the login identifier of the user.
S430, clearing the transferred content in the cloud sharing space in response to the first operation for the first application interface.

When the first operation of the first application interface in the three-dimensional computer-generated environment is detected, the target information in the first application interface needs to be forwarded through the cloud sharing space. Therefore, in order to ensure the accuracy of information transferring, it is first determined whether the content previously transferred is currently stored in the cloud sharing space, that is, the transferred content in the present disclosure. If the transferred content exists in the cloud sharing space, before the target information in the first application interface is forwarded to the application interface in the other operating system through the cloud sharing space, the transferred content in the cloud sharing space may be first cleared, the transferred content before the cloud sharing space is prevented from affecting the target information that needs to be transferred this time, and the accuracy of information transfer between the application interfaces under different types of operating systems is ensured.
S440, uploading the target information obtained by the first operation to the bound cloud sharing space.
S450, controlling the cloud sharing space to transform from a transferable state to an untransferable state, and informing the untransferable state of the cloud sharing space to other application interfaces within the three-dimensional computer-generated environment that are in different types of operating systems from the first application.

After the target information in the first application interface is uploaded to the bound cloud sharing space, in order to avoid being affected by the information transfer in the application interface under other operating systems, it is required that the cloud sharing space does not support the information transferring of the application interface under other operating systems during the information transferring of any application interface under any operating system.

Therefore, the cloud sharing space can be controlled to transform from the transferable state to the untransferable state, so that the cloud sharing space cannot be backed up for the target information uploaded by the application interface under other operating systems during the information transferring of the first application interface.

In addition, the untransferable state of the cloud sharing space can be informed to other application interfaces in the three-dimensional computer-generated environment and under different types of operating systems according to the present disclosure, so that when the user initiates information transferring through the application interface under other operating systems, the cloud sharing space can be timely acquired to be in the untransferable state, and the information transferring of the application interface under other operating systems is delayed.
S460, in response to the second operation for the second application interface, transferring the target information to the second application interface for presentation through the cloud sharing space.
S470, controlling the cloud sharing space to transform from the untransferable state back to the transferable state, and informing each application interface within the three-dimensional computer-generated environment of the transferable state of the cloud sharing space.

After the target information in the first application interface is presented in the second application interface through the cloud sharing space, it indicates that the cloud sharing space has completed this information transferring from the first application interface to the second application interface. Therefore, the cloud sharing space can be controlled to change from the untransferable state back to the transferable state, so that the uploaded target information is backed up when the application interface initiation information under each operating system is transferred.

In addition, the transferable state of the cloud sharing space can be notified to each application interface in the three-dimensional computer-generated environment, so that when the user initiates information transmission on the application interface under each operating system, the target information in the application interface can be normally uploaded to the cloud sharing space, thereby ensuring successful information transferring between the application interfaces under different types of operating systems.

According to the technical solutions provided by the present disclosure, when each user logs in the three-dimensional computer-generated environment, a cloud sharing space can be allocated to each user, and the cloud sharing space is bound with the login identifier of the user one by one, so that the accuracy of cloud sharing space for information transmission is ensured. Moreover, by controlling the transfer state transform of the cloud sharing space during the information transfer, reliability of information transferring between the application interfaces under different types of operating systems in the three-dimensional computer-generated environment is ensured.

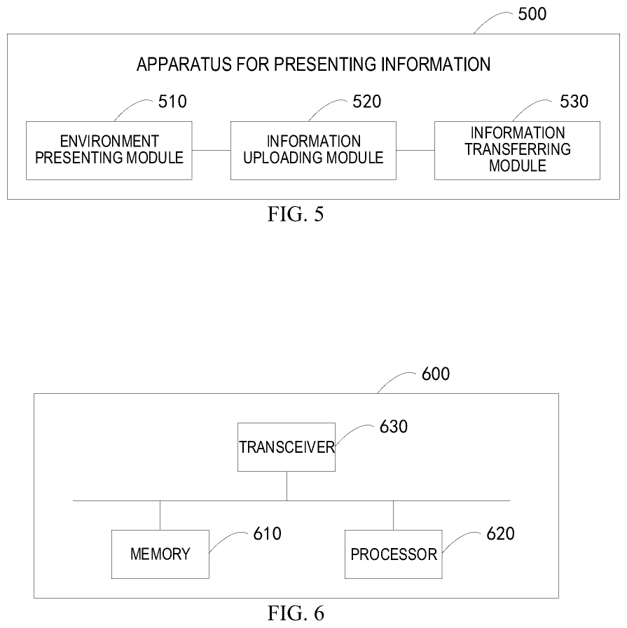

FIG. 5 is a schematic diagram of an apparatus for information presentation according to an embodiment of the present disclosure. The apparatus 500 for information presentation is configured at an electronic device in communication with a display and one or more input devices. The apparatus 500 for information presentation may include:
an environment presentation module 510 configured to present a three-dimensional computer-generated environment via the display, and display a first application interface and a second application interface on the three-dimensional computer-generated environment, the first application and the second application being of different types of operating system applications;
an information uploading module 520 configured to upload target information obtained by a first operation to a bound cloud sharing space in response to the first operation for the first application interface;
an information transferring module 530 configured to transfer the target information to the second application interface for presentation through the cloud sharing space in response to a second operation for the second application interface.

In some implementations, the information uploading module 520 may be specifically configured to:
cache the target information obtained by the first operation through a first system cache area corresponding to the first application interface;
back up the target information in the bound cloud sharing space through the first system cache area.

In some implementations, the information presentation apparatus 500 may further include:
a first clearing module configured to clear the cached target information in the first system cache area.

In some implementations, the information transferring module 530 may be specifically configured to:
download the target information to a second system cache corresponding to the second application interface through the cloud sharing space;
transfer the target information to the second application interface for presentation through the second system cache area.

In some implementations, the apparatus 5000 for information presentation may further include:
a second clearing module configured to clear the cached content in the second system cache area.

In some implementations, the apparatus 500 for information presentation may further include:
a cloud sharing space binding module configured to, in response to a user login operation in the three-dimensional computer-generated environment, allocate a corresponding cloud sharing space to the user, and bind the corresponding cloud sharing space to the login identifier of the user.

In some implementations, the apparatus 500 for information presentation may further include:
a third clearing module configured to clear the transferred content in the cloud sharing space.

In some implementations, the apparatus 500 for information presentation may further include a state transformation module.

a state transformation module configured to after uploading the target information obtained by the first operation to the bound cloud sharing space, control the cloud sharing space to transform from a transferable state to an untransferable state, and inform the untransferable state of the cloud sharing space to other application interfaces within the three-dimensional computer-generated environment that are in different types of operating systems from the first application.

The state transformation module may be further configured to after transferring the target information to the second application interface for presentation through the cloud sharing space, control the cloud sharing space to transform from the untransferable state back to the transferable state, and inform each application interface within the three-dimensional computer-generated environment of the transferable state of the cloud sharing space.

In some implementations, the target information includes text information, a picture, an audio, and a video in the first application interface.

In embodiments of the present disclosure, the three-dimensional computer-generated environment is presented via the display of the electronic equipment, the first application interface and the second application interface are displayed on the three-dimensional computer-generated environment, and the first application and the second application are of different types of operating system applications. Then, for the first application interface and the second application interface under different types of operating systems in the three-dimensional computer-generated environment, when the first operation for the first application interface is detected, the target information obtained by the first operation may be uploaded to the bound cloud sharing space. Then, when the second operation for the second application interface is detected, the target information can be transferred to the second application interface for presentation through the cloud sharing space, thereby realizing seamless transmission of information between application interfaces under different types of operating systems in the three-dimensional computer-generated environment, eliminating the problem of information islanding existing between application interfaces under different types of operating systems, ensuring comprehensive applicability of information transmission in the three-dimensional computer-generated environment, and improving convenience and reliability of information transmission in the three-dimensional computer-generated environment.

It should be understood that the apparatus embodiments and the method embodiments in the present disclosure may correspond to each other, and similar descriptions may refer to the method embodiments in the present disclosure. To avoid repetition, details are not described herein again.

Specifically, the apparatus 500 shown in FIG. 5 may perform any method embodiment provided in the present disclosure, and the foregoing and other operations and/or functions of each module in the apparatus 500 shown in FIG. 5 are respectively used to implement corresponding processes of the foregoing method embodiments.

The foregoing method embodiments of embodiments of the present disclosure are described above with reference to the perspective of the functional modules in combination with the accompanying drawings. It should be understood that the functional module may be implemented in hardware, or may be implemented by using an instruction in a form of software, or may be implemented by combining hardware and software modules. Specifically, steps in the method embodiment in this embodiment of the present disclosure may be completed by using an integrated logic circuit of hardware in a processor and/or an instruction in a form of software, and steps of the method disclosed in this embodiment of the present disclosure may be directly embodied as execution of a hardware decoding processor, or performed by combining hardware and software modules in a decoding processor. Optionally, the software module may be located in a mature storage medium in the art such as a random access memory, a flash memory, a read-only memory, a programmable read-only memory, an electrically erasable programmable memory, a register, and the like. The storage medium is located in the memory, the processor reads information in the memory, and completes the steps in the foregoing method embodiments in combination with hardware of the storage medium.

FIG. 6 is a schematic block diagram of an electronic device according to an embodiment of the present disclosure.

As shown in FIG. 6, the electronic device 600 may include:

The memory 610 is configured to store a computer program, and transmit the program code to the processor 620. In other words, the processor 620 may invoke and run the computer program from the memory 610 to implement the method in this embodiment of the present disclosure.

For example, the processor 620 may be configured to perform the foregoing method embodiments according to the instructions in the computer program.

In some embodiments of the present disclosure, the processor 620 may include, but is not limited to:
a general-purpose processor, a digital signal processor (DSP), an application specific integrated circuit (ASIC), a field programmable gate array (FPGA), another programmable logic device, a discrete gate or transistor logic device, a discrete hardware component, or the like.

In some embodiments of the present disclosure, the memory 610 includes, but is not limited to:
volatile memory and/or non-volatile memory. The non-volatile memory may be a read-only memory (ROM), a programmable read-only memory (programmable ROM, PROM), an erasable programmable read-only memory (Erasable PROM, EPROM), an electrically erasable programmable read-only memory (Electrically EPROM, EEPROM), or a flash memory. The volatile memory may be a random access memory (RAM), which serves as an external cache. By way of example and not limitation, many forms of RAM are available, such as Static Random Access Memory (Static RAM, SRAM), Dynamic Random Access Memory (Dynamic RAM, DRAM), Synchronous Dynamic Random Access Memory (SDRAM), Double Data Rate SDRAM (DDR SDRAM), Enhanced SDRAM (ESDRAM), Synch link DRAM (SLDRAM), and Direct Rambus RAM (DR RAM).

In some embodiments of the present disclosure, the computer program may be divided into one or more modules, and the one or more modules are stored in the memory 610 and executed by the processor 620 to complete the method provided in the present disclosure. The one or more modules may be a series of computer program instruction segments capable of completing a specific function, and the instruction segment is used to describe an execution process of the computer program in the electronic device 600.

As shown in FIG. 6, the electronic device may further include:
a transceiver 630 may be connected to the processor 620 or the memory 610.

The processor 620 may control the transceiver 630 to communicate with another device. Specifically, the transceiver 630 may send information or data to another device, or receive information or data sent by another device. The transceiver 630 may include a transmitter and a receiver. The transceiver 630 may further include an antenna, and there may be one or more antennas.

It should be understood that each component in the electronic device 600 is connected to the bus system, where the bus system includes, in addition to a data bus, a power bus, a control bus, and a status signal bus.

The present disclosure further provides a computer storage medium, where a computer program is stored, and when the computer program is executed by a computer, the computer can perform the method in the foregoing method embodiments.

An embodiment of the present disclosure further provides a computer program product including instructions, and when the instructions are executed by a computer, the computer performs the method in the foregoing method embodiments.

When implemented using software, it may be implemented in whole or in part in the form of a computer program product. The computer program product includes one or more computer instructions. When the computer program instructions are loaded and executed on a computer, the processes or functions according to the embodiments of the present disclosure are all or partially generated. The computer may be a general purpose computer, a special purpose computer, a computer network, or other programmable device. The computer instructions may be stored in a computer-readable storage medium or transmitted from one computer-readable storage medium to another computer-readable storage medium, for example, the computer instructions may be transmitted from a website site, a computer, a server, or a data center to another website site, computer, server, or data center over a wired (e.g., coaxial cable, optical fiber, digital subscriber line (DSL)) or wireless (e.g., infrared, wireless, microwave, etc.). The computer-readable storage medium may be any available medium that can be accessed by a computer or a data storage device such as a server or a data center integrated with one or more available media. The usable medium may be a magnetic medium (for example, a floppy disk, a hard disk, a magnetic tape), an optical medium (for example, a digital video disc (DVD)), a semiconductor medium (for example, a solid state disk (SSD)), or the like.

The foregoing is only a specific embodiment of the present disclosure, but the protection scope of the present disclosure is not limited thereto, and any person skilled in the art may easily conceive of variations or replacements within the technical scope of the present disclosure, and should be covered within the protection scope of the present disclosure. Therefore, the protection scope of the present disclosure should be based on the protection scope of the claims.

I/we claim:

1. A method for presenting information, comprising:
at an electronic device in communication with a display and one or more input devices:
presenting a three-dimensional computer-generated environment via the display, and displaying a first application interface and a second application interface on the three-dimensional computer-generated environment, the first application and the second application being of different types of operating system applications;
in response to a first operation for the first application interface, uploading target information obtained by the first operation to a bound cloud sharing space; and
in response to a second operation for the second application interface, transferring the target information to the second application interface for presentation through the cloud sharing space.

2. The method of claim 1, wherein uploading the target information obtained by the first operation to the bound cloud sharing space comprises:
caching the target information obtained by the first operation through a first system cache area corresponding to the first application interface; and
backing up the target information in the bound cloud sharing space through the first system cache area.

3. The method of claim 2, wherein after backing up the target information in the bound cloud sharing space through the first system cache area, the method further comprises:
clearing the cached target information in the first system cache area.

4. The method of claim 1, wherein transmitting the target information to the second application interface for presentation through the cloud sharing space comprises:
downloading the target information to a second system cache corresponding to the second application interface through the cloud sharing space; and
transferring the target information to the second application interface for presentation through the second system cache area.

5. The method of claim 4, wherein before downloading the target information to the second system cache corresponding to the second application interface through the cloud sharing space, the method further comprises:
clearing cached content in the second system cache area.

6. The method of claim 1, further comprising:
in response to a user login operation in the three-dimensional computer-generated environment, allocating a corresponding cloud sharing space for the user, and binding the corresponding cloud sharing space to a login identifier of the user.

7. The method of claim 1, wherein before uploading the target information obtained by the first operation to the bound cloud sharing space, the method further comprises:
clearing transferred content in the cloud sharing space.

8. The method of claim 1, wherein after uploading the target information obtained by the first operation to the bound cloud sharing space, the method further comprises:
controlling the cloud sharing space to transform from a transferable state to an untransferable state, and informing the untransferable state of the cloud sharing space to other application interfaces within the three-dimensional computer-generated environment that are in different types of operating systems from the first application; and
wherein after transferring the target information to the second application interface for presentation through the cloud sharing space, the method further comprises:
controlling the cloud sharing space to transform from the untransferable state back to the transferable state, and informing each application interface within the three-dimensional computer-generated environment of the transferable state of the cloud sharing space.

9. The method of claim 1, wherein the target information comprises text information, a picture, an audio, and a video in the first application interface.

10. An electronic device, comprising:
a processor; and
a memory, configured to store an executable instruction of the processor;
the processor is configured to execute a method comprising:
presenting a three-dimensional computer-generated environment via the display, and displaying a first application interface and a second application interface on the three-dimensional computer-generated environment, the first application and the second application being of different types of operating system applications;
in response to a first operation for the first application interface, uploading target information obtained by the first operation to a bound cloud sharing space; and
in response to a second operation for the second application interface, transferring the target information to the second application interface for presentation through the cloud sharing space.

11. The electronic device of claim 10, wherein uploading the target information obtained by the first operation to the bound cloud sharing space comprises:
caching the target information obtained by the first operation through a first system cache area corresponding to the first application interface; and
backing up the target information in the bound cloud sharing space through the first system cache area.

12. The electronic device of claim 11, wherein after backing up the target information in the bound cloud sharing space through the first system cache area, the method further comprises:
clearing the cached target information in the first system cache area.

13. The electronic device of claim 10, wherein transmitting the target information to the second application interface for presentation through the cloud sharing space comprises:
downloading the target information to a second system cache corresponding to the second application interface through the cloud sharing space; and
transferring the target information to the second application interface for presentation through the second system cache area.

14. The electronic device of claim 13, wherein before downloading the target information to the second system cache corresponding to the second application interface through the cloud sharing space, the method further comprises:
clearing cached content in the second system cache area.

15. The electronic device of claim 10, wherein the method further comprises
in response to a user login operation in the three-dimensional computer-generated environment, allocating a corresponding cloud sharing space for the user, and binding the corresponding cloud sharing space to a login identifier of the user.

16. The electronic device of claim 10, wherein before uploading the target information obtained by the first operation to the bound cloud sharing space, the method further comprises:
clearing transferred content in the cloud sharing space.

17. The electronic device of claim 10, wherein after uploading the target information obtained by the first operation to the bound cloud sharing space, the method further comprises:
controlling the cloud sharing space to transform from a transferable state to an untransferable state, and informing the untransferable state of the cloud sharing space to other application interfaces within the three-dimensional computer-generated environment that are in different types of operating systems from the first application; and
wherein after transferring the target information to the second application interface for presentation through the cloud sharing space, the method further comprises:
controlling the cloud sharing space to transform from the untransferable state back to the transferable state, and informing each application interface within the three-dimensional computer-generated environment of the transferable state of the cloud sharing space.

18. The electronic device of claim 10, wherein the target information comprises text information, a picture, an audio, and a video in the first application interface.

19. A non-transitory computer-readable storage medium having a computer program stored thereon, wherein the computer program, when executed by a processor, implements a method, comprising:
presenting a three-dimensional computer-generated environment via the display, and displaying a first application interface and a second application interface on the three-dimensional computer-generated environment, the first application and the second application being of different types of operating system applications;
in response to a first operation for the first application interface, uploading target information obtained by the first operation to a bound cloud sharing space; and
in response to a second operation for the second application interface, transferring the target information to the second application interface for presentation through the cloud sharing space.

20. The non-transitory computer-readable storage medium of claim 19, wherein uploading the target information obtained by the first operation to the bound cloud sharing space comprises:
caching the target information obtained by the first operation through a first system cache area corresponding to the first application interface; and
backing up the target information in the bound cloud sharing space through the first system cache area.
